(19) United States
(12) Patent Application Publication
(10) Pub. No.: US 2005/0127064 A1
(43) Pub. Date: Jun. 16, 2005

(54) Domestic appliance, in particular cooking appliance comprising a memory unit

(75) Inventors: Jose-Andres Garcia, Zaragoza (ES); Thomas Lieb, Starnberg (DE); Hans Rogenhofer, Holzkirchen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/020,518

(22) Filed: Dec. 22, 2004

(30) Foreign Application Priority Data
Jun. 24, 2002 (DE) 10228139.4
Jun. 24, 2003 (WO) PCT/EP03/06634

(51) Int. Cl. H05B 1/02

(52) U.S. Cl. 219/492

(57) ABSTRACT

A domestic cooking appliance, which can be conveniently controlled. The appliance includes at least one heating element and a control device. The control device with a write unit for logging process parameters in a memory unit and a read unit for reading out the logged process parameters operate together to at least partially control a cooking process in the appliance.

A cooking appliance with a plurality of heating elements and a control device as well as a memory unit is known from DE 296 05 567 U1. In one embodiment it is provided that electrical, non-volatile memory means are provided to store additional variables and/or cycle times which are varied compared with variables and/or cycle times stored fixedly in an EEPROM. It is thereby achieved that various cooking and/or baking times, heating and/or parboil/simmer temperatures and the like can be stored.

Varied settings are input via suitable up/down buttons. Thus, an arbitrary temperature can be initially pre-selected and then a desired operating mode can be released by actuating a corresponding program button or first the operating mode and then an arbitrary temperature is set.

The object of the invention is to provide a domestic appliance, e.g. in particular a cooking appliance which is more convenient to use. The object is solved according to the invention by the features of claim 1 whilst advantageous embodiments and further developments of the invention can be obtained from the dependent claims.

A domestic appliance, in particular a cooking appliance is proposed which has at least one heating element and a control device as well as a write unit which can be used to log the process parameters for process stages in an at least partly automated manner in a memory unit, and which comprises a read unit which can read out the logged process parameters from the memory unit, wherein an output unit can at least output variables relating to the duration of a process stage and the heating performance delivered during a process stage, and the process parameters can be used for at least partially automated control of a process by means of the control device. Process sequences can be conveniently stored and then simply checked, identified and selected. Variables relating to a heating performance delivered in a process stages should be understood in this connection as temperature values, power values, for example, wattage, abstract power stages, for example, values between zero and nine, etc.

If the at least individual variables can be successively output for the process stages via the output unit, firstly the processes can be shown particularly clearly, especially for identification, and inexpensive output units can be achieved.

The variables for the process stages can be executed such that they can be successively retrieved manually and/or in at least one operating state the control device successively outputs the variables for the process stages automatically via the output unit. In the latter case, manual inputs to output variables can be at least largely avoided and the convenience can again be increased.

If the control device outputs at least individual variables before the start of an at least partially automated process along logged process parameters to identify the process via the output unit, the user can conveniently, simply and quickly identify whether the stored process parameters for example are suitable for the preparation of the food planned to be cooked.

If at least one further variable can be input for stored process parameters via an input unit and stored in the memory unit, the allocation and identification can be further simplified and the cooking results further improved with the logged process parameters. The input can be made acoustically, for example, via a speech recognition and/or via buttons, toggles etc. With the additional variable which can be input, various aspects which appear meaningful to the person skilled in the art can be described in more detail, such as for example prepared food to be cooked, a cooking result, boiling instructions, ingredients, times of incorporating ingredients and their state before and/or after the process, handling of a cover, an advantageous stirring behaviour etc.

If at least one logged process parameter can be varied via an input unit before and/or during an automated process sequence, a fine tuning can advantageously be carried out by the user and the process can be matched to certain boundary conditions such as, for example, the quantity and/or consistency of food to be cooked. In order to avoid additional components as far as possible, the input unit for inputting at least one further variable and/or the input unit for varying at least one logged process parameter can advantageously be executed at least integrally with an input unit for controlling the heating element already provided as standard.

Instead of before the start of an automated process, variables can especially be output via the output unit for currently logged parameters after a process has been carried out so that the user can check the logged process parameters. If the result of the process and/or accordingly the logged process parameters did not correspond to the ideas of the user, it is possible to provide a function with which the user can prevent a permanent storage of the currently logged process parameters or can correct the logged process parameters.

In a further embodiment of the invention it is proposed that at least one logged process parameter can be automatically optimised by means of a processing unit with respect to at least one criterion such as for example energy consumption, vitamin content etc, whereby improved processes can be achieved. For this purpose corresponding index fields and/or algorithms can be deposited in the memory unit.

The variables can be output via the output unit acoustically, especially in the form of speech, and/or visually. If the variables can be output via the output unit by means of a diagram with at least two coordinates, an especially clear representation can be achieved.

In a further embodiment of the invention it is proposed that, in addition to the function of outputting the variables, the output unit has at least one further function. Additional components as well as assembly and costs associated therewith can at least be largely avoided. It is especially advantageous if an already existing output unit for outputting currently set temperatures, power stages, time values etc. is executed at least largely integrally with the output unit for outputting the variables.

If the output unit comprises at least one display element which has seven segments for displaying a number from zero to nine, an inexpensive output unit can be achieved with which the variables can be very clearly displayed.

In order to continuously ensure clear usage, the number of logged process stages is restricted to a number less than 10. Furthermore the logging time is advantageously restricted to a time interval of less than two hours.

Further advantages are obtained from the following description of the drawings. The drawings show exemplary embodiments of the invention. The drawings, the description and the claims contain numerous features in combination. The person skilled in the art will more appropriately also consider the features individually and combine them into meaningful further combinations.

In the figures:

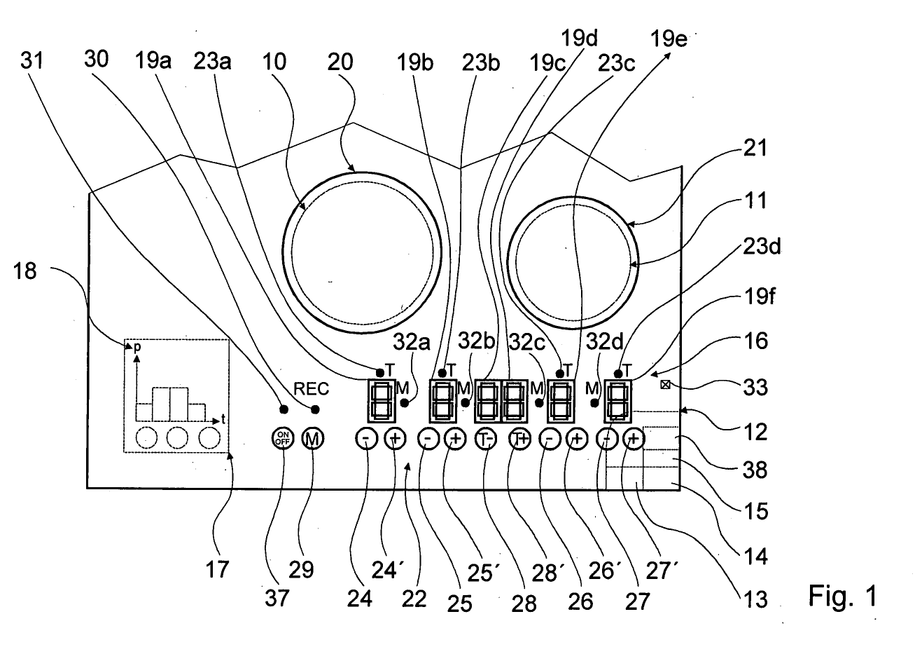

FIG. 1 is a section of a cooking appliance shown schematically from above with a sensor control system on the cover side of the cooking appliance and

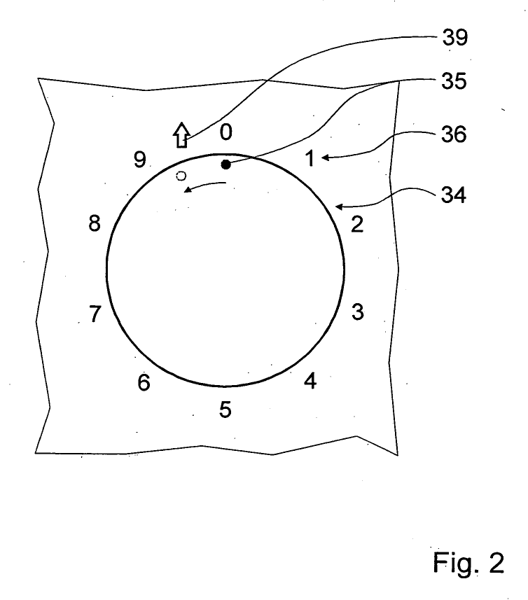

FIG. 2 is a rotary toggle of an alternative cooking appliance.

FIG. 1 shows a cooking appliance with four hot plates 20, 21, only two of the four hot plates 20, 21 being shown. Associated with each of the hot plates 20, 21 is a heating element 10, 11 which are arranged underneath a cover side of the cooking appliance. The cooking appliance also has a control device 12 which has an integrated write unit 13, an integrated memory unit 14, an integrated read unit 15 and an integrated processing unit 38.

The heating elements 10, 11 can be controlled by a user by means of a sensor control system 22 on the cover side of the cooking appliance and by means of the control device 12. The sensor control system 22 can be switched on and off using a first so-called on/off sensor 37. When the sensor control system 22 is switched on, a signal light 31 lights up above the sensor 37. When the sensor control system 22 is switched on, a heating step can be set for each hot plate 20, 21 by means of respectively two sensors 24, 24′, 25, 25′, 26, 26′, 27, 27′ and the respective heating step can be increased using a sensor 24′, 25′, 26′, 27′ labelled “plus” and the respective heating step can be reduced using a sensor 24, 25, 26, 27 labelled “minus”. The heating step selected by the user is in each case displayed to the user by means of a display element 19a, 19b, 19e, 19f with seven luminous segments associated with the corresponding hot plate 20, 21, wherein numbers from zero to nine respectively can be displayed using the display elements 19a, 19b, 19e, 19f.

In addition, the cooking appliance has a timer unit which can be used to set how long a hot plate 20, 21 should be operated with a certain heating step. The time unit comprises two sensors 28, 28′ on the cover side of the cooking appliance via which the user can set a certain heating time and specifically a sensor 28′ labelled “plus” to lengthen the heating time and a sensor 28 labelled “minus” to shorten the heating time. The selected heating time is displayed in two display elements 19c, 19d each having seven luminous segments. Furthermore, it is also displayed to the user via signal lights 23a, 23b, 23c, 23d for which hot plate 20, 21 the time unit is activated, the signal lights 23a, 23b, 23c, 23d each being arranged above the display elements 19a, 19b, 19e, 19f.

If process parameters are to be logged in automated fashion via the write unit 13 in the memory unit 14 for process stages of a cooking process, for this purpose the user must touch the sensor 29 labelled “M” for longer than 0.5 sec. A signal light 30 labelled “REC” then displays to the user by lighting up that it is ready to log or ready to receive. Furthermore, a signal light 32a, 32b, 32c or 32d labelled “M” of the last heating element 10, 11 activated flashes, the signal lights 32a, 32b, 32c, 32d associated with the heating elements 10, 11 being arranged respectively next to the display elements 19a, 19b, 19e, 19f associated with the heating elements 10, 11. If a heating element 10 or 11 is only activated after actuating the sensor 29, the signal light 32a, 32b, 32c or 32d associated with the heating element 10 or 11 begins to flash immediately the heating element 10 or 11 is activated. Receiving begins 5 sec after the read unit 15 has been activated by the user or 5 sec after the following activation of a heating element 10 or 11 if no heating element 10 or 11 is activated at the time of activating the read unit 15. The duration of the process stage of the individual process stages is in this case received with a resolution of 10 sec but other resolutions which appear meaningful to the person skilled in the art are also feasible.

If the cooking appliance has a function via which a present temperature can be kept constant, such as is especially the case with induction heating elements, the times at which the function is activated and deactivated and the corresponding temperature for the automated control of a following process are logged via the read unit 15.

In order to ensure clear logging of a process, the control device 12 only allows the logging of a single process at the same time. If an attempt is made to log a second process at a second heating element 10 or 11 parallel to a first process at a first heating element 10 or 11, the signal light 32a, 32b, 32c or 32d labelled “M”, associated with the second heating element 10 or 11 flashes three times in order to signal to the user that the logging of the second process is rejected.

The readiness to receive is interrupted if the user touches the sensor 29 again for longer than 0.5 sec, he actuates the sensor 37, he set the cooking step to zero or a maximum number of process stages or a maximum receiving time is exceeded. The number of receivable process steps is advantageously limited to 5 and the receiving time is limited to 99 min. If the readiness to receive is interrupted, the signal light 30 labelled “REC” and the signal light 32a, 32b, 32c or 32d labelled “M” goes out.

If the stored process parameters are to be read out from the memory unit 14 via the read unit 15 and used for automated control of a cooking process via the control device 12, for this purpose the user must simultaneously actuate the sensors 24, 24′, 25, 25′, 26, 26′ or 27, 27′ labelled “plus” or “minus” of the hot plate 20 or 21 to be selected or touch the sensor 29 labelled “M” for less than 0.5 sec before or after activating a heating element 10, 11. The signal lights 23a, 23b, 23c or 23d and 32a, 32b, 32c or 32d associated with the selected heating element 10 or 11 begin to light up.

Before starting the automated cooking process along the logged process parameters, the control device 12 outputs respectively one variable relating to the duration of the process stage and one variable relating to the heating performance selected in the process stage via the output unit 16 to identify the cooking process successively for the process stages and for each process stage the duration of the process stage in minutes is displayed for 2 sec in the display elements 19c, 19d and the heating step is displayed in the display element 19a, 19b, 19e or 19f associated with the selected heating element 10, 11.

After the brief overview the control device 12 controls the selected heating element 10 or 11 automatically along the logged process parameters, wherein the respectively present heating step is displayed in the display element 19a, 19b, 19e or 19f of the heating element 10 or 11 and the remaining total time of the cooking process is displayed in the display elements 19c, 19d. During the automated cooking process the heating step and the duration of the process stage cannot be varied by the user via the sensor control system 22.

If the user touches the sensor 28 labelled “minus” of the timer unit during the automated cooking process, the remaining heating time with the present heating step or the remaining duration of the process stage is displayed to the user for 3 sec. If the sensor 28′ labelled “plus” is touched by the user, the heating step and the duration of the process stage of the following process stages is displayed to the user. If the sensor 28′ is touched twice in succession, the heating step and the process stage duration of the next but one process stage is displayed to the user etc.

At the end of the cooking process a beep tone is emitted via a loudspeaker 33 and zeros are displayed in the display elements 19c, 19d.

The stored process parameters associated with a heating element 10 or 11 can be deleted from the memory unit 14 by activating the read unit 15 at the heating step zero of the heating element 10 or 11.

Instead of or in addition to the first output unit 16, an alternative output unit 17 can be provided. In FIG. 1 on the side of the on/off sensor 37 facing away from the first output unit 16, a second input and output unit 17 formed by a so-called touch screen is indicated, via which further variables can be input and stored in the memory unit 14. A microphone not shown in detail can be activated via the input and output unit 17 and a name can be assigned to a stored process via speech recognition, which is output before starting the automated process acoustically via the loudspeaker 33 and visually via the screen of the input and output unit 17. In addition, cooking results and recipe proposals and other notes can be input via speech recognition and output both acoustically and visually.

Furthermore, variables can be output by means of a diagram 18 with a time coordinate and a power coordinate via the input and output unit 17.

Furthermore, individual process parameters can be varied via the input and output unit 17 and especially optimised with respect to certain criteria and specifically with respect to power consumption and vitamin content. For this purpose, various index fields are deposited in the memory unit 14 with which the stored process parameters are balanced by means of the processing unit 38 of the control device 12.

In addition to the cooking appliance shown, the solution according to the invention can be used in all cooking appliances which appear suitable to the person skilled in the art and especially in cooking appliances whose heating elements are controllable by means of piezosensors and/or rotary toggles. FIG. 2 shows a rotary toggle 34 of a heating element of a cooking appliance. The activation and deactivation of a write and read unit via the rotary toggle 34 is described subsequently as an example wherein reference can basically be made to the description relating to the exemplary embodiment in FIG. 1 with regard to further sequences and functions.

In order to activate the write unit, the rotary toggle 34 is turned into a turning position or a so-called memory position in which a marker 35 on the rotary toggle 34 comes to lie between a number zero and nine of a scale 36 applied to a front side of a cooking appliance. The memory position is indicated with an arrow 39 on the scale 36. The rotary toggle 34 is then pressed for longer than 0.5 sec.

The write unit can be deactivated via the rotary toggle 34 by turning the rotary toggle 34 back to its zero position or if this is turned out from its memory position, then turning it back into the memory position and leaving it in this position for longer than 5 sec.

In order to start the read unit and thus an automated process along logged process parameters, the rotary toggle 34 is turned into its memory position. The process can be interrupted by means of the rotary toggle 34 by turning this out of its memory position during the process.

### REFERENCE LIST

10 Heating element
11 Heating element
12 Control device
13 Write unit
14 Memory unit
15 Read unit
16 Output unit
17 Input and output unit
18 Diagram
19 Display element
20 Hot plate
21 Hot plate
22 Sensor control system
23 Signal light
24 Sensor
25 Sensor
26 Sensor
27 Sensor
28 Sensor
29 Sensor
30 Signal light
31 Signal light
32 Signal light
33 Loudspeaker
34 Rotary toggle
35 Marker
36 Scale
37 Sensor
38 Processing unit
39 Arrow

1-11. (canceled)

12. A domestic cooking appliance, comprising:
at least one heating element;
a control device;
a memory unit;
a write unit for logging at least one process parameter for at least one process stage for said heating element in said memory unit;
a read unit for reading out said logged process parameter from said memory unit for said process stage;
at least one output unit for outputting at least one variable relating to a duration of said process stage and for the heating performance of said heating element during said process stage; and
said process parameter utilized by said control device to at least partially automatically control said process stage of said heating element.

13. The domestic cooking appliance according to claim 12, including a plurality of process stages and said output unit outputting at least one individual variable for each successive process stage.

14. The domestic cooking appliance according to claim 13, including said control device includes at least one operating state for automatically outputting said variables for said successive process stages via said output unit.

15. The domestic cooking appliance according to claim 14, including said control device outputting said individual variables before the start of said at least partially automatically process stage utilizing logged process parameters to identify said process stage via said output unit.

16. The domestic cooking appliance according to claim 12, including an input unit for inputting and logging at least one further stored process parameter variable in said memory unit.

17. The domestic cooking appliance according to claim 12, including an input unit for varying at least one stored process parameter variable in said memory unit.

18. The domestic cooking appliance according to claim 12, including a processing unit for optimizing at least one stored process parameter variable in said memory unit with respect to at least one criterion.

19. The domestic cooking appliance according to claim 12, including said output unit outputting at least one variable utilizing a diagram with at least two coordinates.

20. The domestic cooking appliance according to claim 12, including said output unit including at least one further function in addition to the function of outputting at least one variable.

21. The domestic cooking appliance according to claim 12, including said output unit including at least one display element having at least seven segments for displaying a number from zero to nine.

22. The domestic cooking appliance according to claim 12, including restricting the number of process stages to a number less than ten(10).
